(19) United States
(12) Patent Application Publication
(10) Pub. No.: US 2006/0168615 A1
(43) Pub. Date: Jul. 27, 2006

(54) System circuit application and method for wireless transmission of multimedia content from a computing platform

(75) Inventors: Eran Igler, Tel Aviv (IL); Michael Genossar, Modi-in (IL); Zeev Shpiro, Tel Aviv (IL)

Correspondence Address: Eitan Law Group;C/O LandonIP, Inc., Suite 450, 1700 Diagonal Road, Alexandria, VA, 22314, US

(73) Assignee: Adimos Inc.

(21) Appl. No.: 11/038,245

(22) Filed: Jan. 21, 2005

(51) Int. Cl. H04N 7/025; H04N 7/16; H04N 7/10

(52) U.S. Cl. 725/32; 725/135; 725/136

(57) ABSTRACT

According to some embodiments of the present invention, a receiver for receiving video content over a wireless data link may include a video encoder adapted to receive data packets containing video content according to fixed data video format and to produce a video signal suitable for a video presentation device with which the receiver is functionally associated. A demodulator/decoder may be adapted to convert into data packets a signal received from a wireless transmitter functionally associated with the computer, wherein the computer may include a video format conversion module running on a central processing unit, and the module may be adapted to transcode to the fixed video data format any content which is not in the fixed video data format and which is to be transmitted to said receiver.

### FIELD OF THE INVENTION

The present invention generally relates to the field of communication. More specifically, the present invention relates to a system, circuit, application and method for transmission of content from a computing platform.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

In the ever evolving field of communications, new forms of media (e.g. sound, images, video, interactive multi-media content, etc.) are constantly being developed and improved. Most homes, business and various other locations in the developed world today have devices capable of receiving and displaying or playing content in various format and media types. More specifically, today's modern home, office, or home-office may contain at least one television, and most likely will also include a multimedia enable computer, a stereo, a DVD player, and a proprietary content provider's (e.g. cable or wireless content provider) decoder box. The terms “Home Theater”, “Home Entertainment Center” or “Media Center” have been coined to designate a set of devices or even complex media presentation systems for the presentation of content to persons within a home or office. With the continual evolution of the various media types in which content is being delivered, the devices and systems used receive and present that content is also evolving and growing in number.

As the number of media types has grown, so has the number of formats by which media may be stored. Today, both audio and video content may each be stored in a multitude of formats according to a multitude of standards. For example, an image may be stored and/or transmitted in formats conforming to either the JPG standard, the Tiff standard, the BMP standard, and anyone one of a multitude of other standards. Similarly, audio content may be stored and/or transmitted using formats conforming to the MP3 standard, the AVI standard, the MPEG 1—layer iii standard, the MPEG 4—AAC standard, or anyone of a number of other standards. Video content may also be stored and/or transmitted according to numerous standards, including MPEG 2, MPEG 4, AVI, and many, many others.

As the number and complexity of devices and systems used is growing, so is the need to interconnect these devices. Since many devices need to be connected with other devices in order to function fully and properly (e.g., a multimedia enabled computer with multimedia content, such as an interactive movie, stored on a mass storage device, such as a hard drive, may be connected to a Video Display and to an Audio Output System), the need for means to establish efficient connections or networks of connections between various home devices and systems is growing. Since modern communication devices and networks today are best characterized by features such as high bandwidth/data-rate, complex communication protocols, various transmission medium, and various access means, solutions for interconnecting media related devices and systems to date have typically centered around wiring the devices to one another using various cables of various configurations and sizes. For example, fiber optic cables, which are used as part of data networks spanning much of the world's surface, are sometimes used to connect the audio output of a CD or a DVD to an Audio System, or a cable may be used to connect a video output port of a multimedia computer to a monitor, a digital screen or even to a television set.

More recently, wireless (i.e. Radio Frequency) transceivers, protocols and networks (Bluetooth, WiFi, WiMax, etc.) have been used to interconnect various devices in the home and office. Since available bandwidth over a wireless connection is inherently smaller than bandwidth over a cable or other physical connection between two points, when transmitting media content from a source to a media presentation device such as video monitor, there is usually compression of the data constituting the content. Since multimedia content is usually stored in a compressed format, in most cases the content may be transmitted in the same format it is stored. For example, if a multimedia presentation, such as a movie stored on a Digital Video Recorder or on a multi-media computer were transmitted (e.g., via WiFi) to a video display of projector, the presentation may be transmitted in the same format it was stored on either on DVD or on a mass storage device associated with the multimedia computer. Movies stored in MPEG 2 format on the DVD may be transmitted to the video monitor in MPEG 2 format, whereas movies stored on the multimedia computer in AVI format may be transmitted to the video monitor in AVI format.

Since wireless transmission of video, audio and image content may be in many different formats, wireless receivers associated with a media presentation device, such as video monitor or projectors, typically require complex multi-standard decoders adapted to convert or transcode content received in one of a multitude of data formats into a single format and signal corresponding to the media presentation device to which it is associated.

There is a need for systems, methods and circuits for reducing the complexity and cost associated with the wireless transmission of multimedia content.

### SUMMARY OF THE INVENTION

In accordance with some embodiments of the present invention, there is provided a receiver for receiving video content over a wireless data link may include a video encoder adapted to receive data packets containing video content according to fixed data video format and to produce a video signal suitable for a video presentation device with which the receiver is functionally associated. A demodulator/decoder may be adapted to convert into data packets a signal received from a wireless transmitter functionally associated with the computer, wherein the computer may include a video format conversion module running on a central processing unit, and the module may be adapted to transcode to the fixed video data format any content which is not in the fixed video data format and which is to be transmitted to said receiver.

According to some embodiments of the present invention, all content, including still image content, audio content and video content stored on a computer may be converted or transcoded into a fixed video data format (e.g. MPEG 2 format) by a format conversion module running either on the computer's central processing unit or on another processor functionally associated with the computer. The converted or transcoded content may be transmitted to a receiver over a wireless transmitter or transceiver which may establish a wireless data link (e.g., WiFi connection or any other wireless data connection known today or to be devised in the future) with a wireless receiver or transceiver. According to some embodiments of the present invention, the receiver may include a wireless demodulator and/or decoder corresponding to the modulator and encoder used by the wireless transmitter associated with the computer.

According to some embodiments of the present invention, the receiver may be functionally associated or connected to a video content presentation device, such as a video monitor or projector. A compressed video decoder may be adapted to receive data packets from the wireless demodulator and/or decoder and to decompress the content within the packets according to a fixed video data format, for example MPEG 2. The decompressed content may be converted into a video signal by a video encoder, such that the video signal corresponds to the video presentation device with which the receiver is functionally associated.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flow diagram showing the steps of an exemplary method by which media stored on a computer may be transmitted according to some embodiments of the present invention;

FIG. 2 is block diagram showing the elements of an exemplary media transmitter block integrated with a computer and an exemplary media receiver functionally associated with a video presentation device, according to some embodiments of present invention;

FIG. 3 is a block diagram showing the elements of an exemplary media transmitter block integrated with a computer and an exemplary media receiver functionally associated with a video presentation device, according to some embodiments of present invention. Also shown in FIG. 3 are some details of the computer's native hardware which may be utilized as part of the present invention; and

FIG. 4 is a conceptual block diagram of an exemplary media conversion/transcoding block integrated into a computer having a wireless data networking components, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

In accordance with some embodiments of the present invention, there is provided a receiver for receiving video content over a wireless data link may include a video encoder adapted to receive data packets containing video content according to fixed data video format and to produce a video signal suitable for a video presentation device with which the receiver is functionally associated. A demodulator/decoder may be adapted to convert into data packets a signal received from a wireless transmitter functionally associated with the computer, wherein the computer may include a video format conversion module running on a central processing unit, and the module may be adapted to transcode to the fixed video data format any content which is not in the fixed video data format and which is to be transmitted to said receiver.

According to some embodiments of the present invention, all content, including still image content, audio content and video content stored on a computer may be converted or transcoded into a fixed video data format, e.g., MPEG 2 format, by a format conversion module running either on the computer's central processing unit or on another processor functionally associated with the computer. The converted or transcoded content may be transmitted to a receiver over a wireless transmitter or transceiver which may establish a wireless data link, e.g., WiFi connection or any other wireless data connection known today or to be devised in the future, with a wireless receiver or transceiver. According to some embodiments of the present invention, the receiver may include a wireless demodulator and/or decoder corresponding to the modulator and encoder used by the wireless transmitter associated with the computer.

According to some embodiments of the present invention, the receiver may be functionally associated or connected to a video content presentation device, such as a video monitor or projector A compressed video decoder may be adapted to receive data packets from the wireless demodulator and/or decoder and to decompress the content within the packets according to a fixed video data format, for example MPEG 2. The decompressed content may be converted into a video signal by a video encoder, such that the video signal corresponds to the video presentation device with which the receiver is functionally associated.

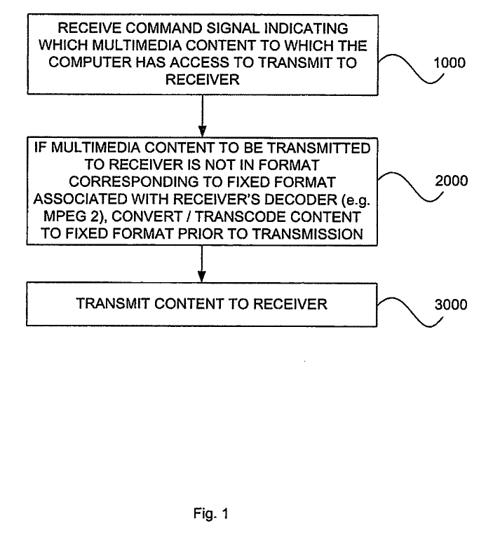

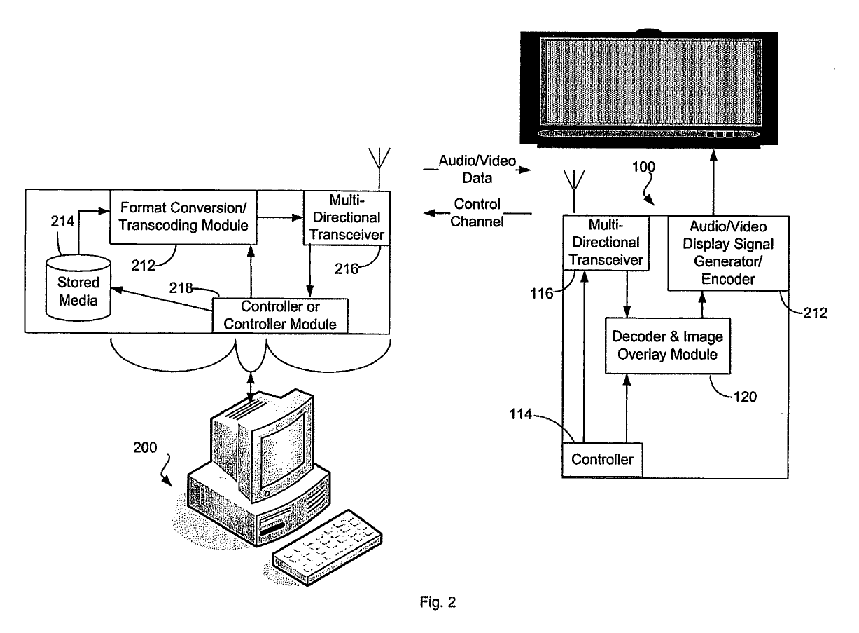

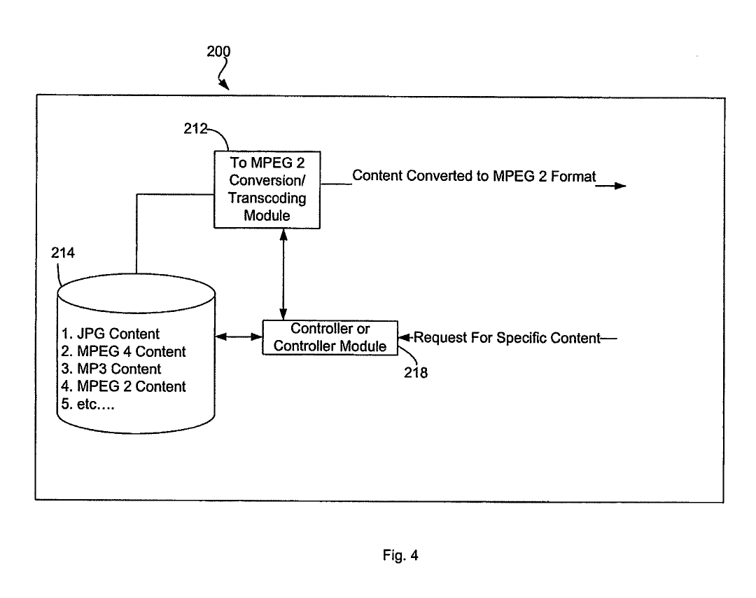

Turning now to FIG. 1 there is shown a flow diagram including the steps of an exemplary method by which media stored on a computer or computing device may be transmitted to a receiver functionally associated with a video presentation device, according to some embodiments of the present invention. The steps of FIG. 1 may be elaborated upon with reference made to FIGS. 2 and 4, where FIG. 2 shows a block diagram including the elements of an exemplary media transmitter block 200 integrated with a computer and an exemplary media receiver 100 functionally associated with a video presentation device, according to some embodiments of present invention. FIG. 4 shows the signal flow within a content transmission block according to an embodiment of the present invention where MPEG 2 is the media format to which content is converted or transcoded.

According to some embodiments of the present invention, media stored on a mass storage device 214 associated with a computer or computing device may be requested (step 1000). A controller 218, or a control module implemented in software running on the computer's central processing unit (or any other processor associated with the computer), may locate the requested content on a mass storage device 214, either functionally associated with the computer or associated with another computing device to which the computer may be connect via a data network such as the Internet. The controller 218 may determine whether the format in which the content is stored corresponds with a format which the receiver's 100 decompression-engine/decoder 120 is able to decode. In the event the media format in which the content is stored does not correspond with the format which the receiver's 100 decompression-engine/decoder 120 is able to decode, the controller 218 may be instructed by a format conversion/transcoding module 212, which transcoding module may be software running on one of the computer's processors, to convert or transcode the stored content into the relevant media format (step 2000), for example MPEG 2, prior to transmission.

Although according to various examples of the present invention described within this application, the content to be transcoded is said to be “stored” on a mass storage device functionally associated with computer, computing device or computer platform, it should be clear to one of ordinary skill in the communication arts that the content may also be stored on another computer to which the first computer is connected via a data network such as the Internet. According to some embodiments of the present invention, the computer may: (1) request content stored on a second computer via a data network connection; (2) transcode portions of the content as they are received from the second computer; and (3) forward the transcoded portions of content to the receiver via a wireless data link. It should be understood that throughout the specification and claims of this application, the term “stored” also includes “stored on a remote computer or computing device.”

According to some embodiments of the present invention, the conversion/transcoding module 212 may transcode portions of content (e.g. several hundred frames or several kilobits at a time) just prior to transmission of the content to the receiver 100. According to some embodiments of the present invention, the conversion/transcoding module may: (1) Use the decoder(s) associated with the given content in order to generate presentation data set(s) (e.g. video screen data to be sent to video card memory or audio data to be sent to audio card memory); (2) intercept the presentation data set before it sent to the relevant presentation device (e.g. video or audio cards), and may convert or encode the presentation set data into a media format which the receiver's 100 decompression-engine/decoder 120 is able to decode.

According to certain embodiments of the present invention, when the requested content's native format is JPEG, or any other native format based on the discrete cosine transform (“DCT”), the content may be transcoded into, for example, MPEG 2 format, or into any other DCT based format, within the DCT domain. Methods and systems for transcoding within the DCT domain content from one DCT based format to another DCT based format are known, and any such method currently known or to be devised in the future may be applicable to the present invention.

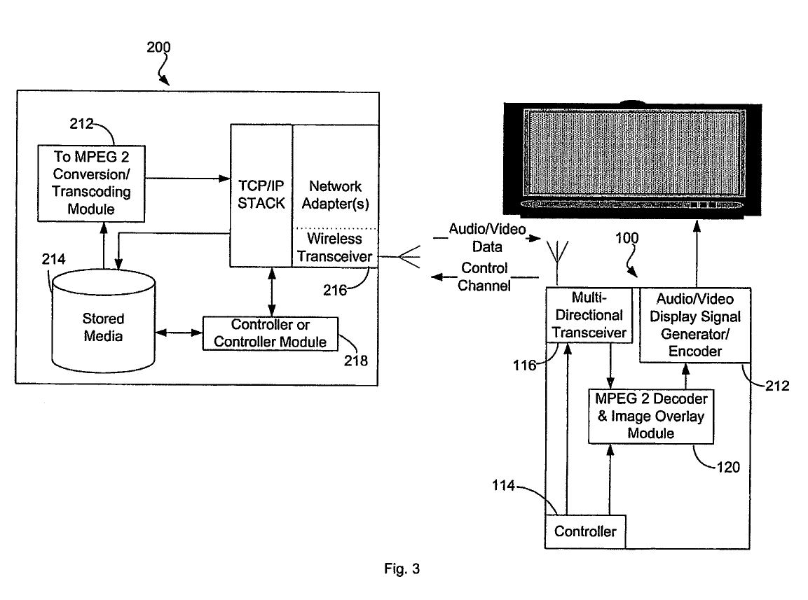

Once a portion of the content has been converted or transcoded (step 2000), it may be transmitted to the receiver 100 via a wireless data link facilitated by wireless transceivers 216 and 116. The data link may conform to any wireless data transmission standard and/or technology known today, including Bluetooth, WiFi, WiMAX, or any other standard and/or technology which may be developed in the future. For example, FIG. 3 shows an embodiment of the present invention where the format to which content is converted is MPEG 2, and the converted content is packetized and transmitted according to a wireless networking protocol and technology such as WiFi. According to the embodiment of FIG. 3, the decoder 120 on the receiver 100 is thus an MPEG 2 decoder.

A wireless demodulator and/or decoder (not shown), which may be part of transceiver 116, may receive a content baring signal transmitted from the transmitter 200 and may produce corresponding content baring data packets. The content within the data packets may be decompressed and/or decoded by a media decoder 120 and the decoded content data may be sent to a video encoder 112, which may generate a signal suitable for a media or video presentation device to which the receiver is functionally associated or connected. A controller 218 on the receiver 100 may coordinate all the above described receiver 100 operations.

According to the exemplary embodiment of FIG. 3, all stored content, including images, audio and video may be converted to MPEG 2 format. The media decoder 112 on the receiver may be an MPEG 2 decoder, and the media presentation device may be a video presentation device and/or an audio presentation device (e.g. audio system).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of transmitting multimedia content from a computer having multimedia content in a plurality of formats to a wireless receiver, said method comprising:
a. transcoding to a fixed video data format any content which is not in the fixed video data format; and
b. transmitting the transcoded video content to the receiver via a wireless transmitter functionally associated with the computer.

2. The method according to claim 1, wherein the fixed video format is MPEG 2.

3. The method according to claim 2, wherein the multimedia content is in JPEG format and transcoding from JPEG format to MPEG 2 format is performed in the discrete cosine transform domain.

4. An article comprising a medium storing instructions that enable a processor-based system to:
a. transcode to a fixed video data format any multimedia content which is not in the fixed video data format; and
b. cause the transcoded video content to be transmitted via a wireless data transmitter functionally associated with the processor-based system.

5. The method according to claim 4, wherein the fixed video format is MPEG 2.

6. The method according to claim 5, wherein the multimedia content is in JPEG format and transcoding from JPEG format to MPEG 2 format is performed in the discrete cosine transform domain.

7. A receiver for receiving video content over a wireless data link, said receiver comprising:
a. a video encoder adapted to receive data packets containing video content according to a fixed video data format and to produce a video signal suitable for a video presentation device with which said receiver is functionally associated; and
b. a demodulator/decoder adapted to convert into data packets a signal received from a wireless transmitter functionally associated with a computer, wherein the computer includes a video format conversion module running on a central processing unit and adapted to transcode to the fixed video data format any multimedia content which is not in the fixed data format and which is to be transmitted to said receiver.

8. The method according to claim 7, wherein the fixed video format is MPEG 2.

9. The method according to claim 8, wherein the multimedia content is in JPEG format and transcoding from JPEG format to MPEG 2 format is performed in the discrete cosine transform domain.

10. A system for transmitting video content comprising:
a. a computer having a video format conversion module running on a central processing unit and adapted to transcode to a fixed video data format any multimedia content which is not in the fixed video data format and which is to be transmitted to a receiver; and
b. a receiver adapted to receive data packets containing video content according to the fixed video data format and to produce a video signal suitable for a video presentation device with which said receiver is functionally associated.

11. The method according to claim 10, wherein the fixed video format is MPEG 2.

12. The method according to claim 11, wherein the multimedia content is in JPEG format and transcoding from JPEG format to MPEG 2 format is performed in the discrete cosine transform domain.
